(19) United States
(12) Patent Application Publication
(10) Pub. No.: US 2013/0247007 A1
(43) Pub. Date: Sep. 19, 2013

(54) MAKING DEBUGGER BEHAVIOR CONDITIONAL ON PAST PROGRAM STATE

(71) Applicants: Robert M. Fuhrer, Peekskill, NY (US); Danny Soroker, Larchmont, NY (US)

(72) Inventors: Robert M. Fuhrer, Peekskill, NY (US); Danny Soroker, Larchmont, NY (US)

(73) Assignee: INTERNATIONAL BUSINESS MACHINES CORPORATION, Armonk, NY (US)

(21) Appl. No.: 13/423,052

(22) Filed: Mar. 16, 2012

(51) Int. Cl. G06F 9/44

(52) U.S. Cl. 717/129

(57) ABSTRACT

A debugger variable is set; the variable is associated with: at least one location within a program to be debugged; and at least one expression that is valid within a scope of the location. A breakpoint associated with a location within the program is also set. Upon encountering the at least one location of the debugger variable during a current run of the program, a value of the at least one expression with which the debugger variable is associated is computed and assigned to the debugger variable. Upon encountering the location of the breakpoint during the current run of the program, the debugger is operated in at least one of a first manner and a second manner, depending on the value of the debugger variable; the first manner is different than the second manner.

### STATEMENT OF GOVERNMENT RIGHTS

Not Applicable.

### CROSS-REFERENCE TO RELATED APPLICATIONS

Not Applicable.

### FIELD OF THE INVENTION

The present invention relates to the electrical, electronic and computer arts, and, more particularly, to application development and the like.

### BACKGROUND OF THE INVENTION

Breakpoints are an important tool used in debugging software. However, not all executions of a given line of source code are equally interesting to the debugging task at hand. For example, a common library subroutine may be called many times from many different contexts during a program's execution. Some of these contexts may be entirely unrelated to the developer's current focus. This requires the developer to repeatedly examine the program state, and ask the debugger to continue execution until a relevant execution context occurs.

As a result, debugging complex scenarios may be further facilitated by the use of a conditional breakpoint, with which a Boolean predicate is associated. This predicate is evaluated each time the corresponding location is reached during program execution. If the predicate evaluates to true, the debugger stops at the breakpoint; if not, program execution continues.

### SUMMARY OF THE INVENTION

Principles of the invention provide techniques for making debugger behavior conditional on past program state. In one aspect, an exemplary method includes the step of setting, for a debugger, a debugger variable associated with: at least one location within a program to be debugged; and at least one expression that is valid within a scope of the at least one location. Further steps include setting a breakpoint associated with a location within the program; upon encountering the at least one location of the debugger variable during a current run of the program, computing a value of the at least one expression with which the debugger variable is associated, and assigning the value of the at least one expression with which the debugger variable is associated to the debugger variable; and, upon encountering the location of the breakpoint during the current run of the program, operating the debugger in at least one of a first manner and a second manner, depending on the value of the debugger variable, the first manner being different than the second manner.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:
Improving the effectiveness of debugger breakpoints by providing a new kind of specification of when the debugger should pause a program at a conditional breakpoint, thus improving the efficiency of program debugging thanks to increased automation.
Improving how the debugger displays data to the programmer by providing a new mechanism for controlling what is displayed and how it is displayed based on past program state.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary process of using debugger variables for conditional breakpoints, according to an aspect of the invention;

FIG. 2 shows exemplary use of a debugger variable and associated conditional breakpoint, according to an aspect of the invention;

FIG. 3 shows exemplary software architecture for debugger variables for conditional breakpoints, according to an aspect of the invention; and

FIG. 4 depicts a computer system that may be useful in implementing one or more aspects and/or elements of the invention.

### DETAILED DESCRIPTION OF PREFERRED EMBODIMENTS

As noted, breakpoints are an important tool used in debugging software. However, not all executions of a given line of source code are equally interesting to the debugging task at hand. For example, a common library subroutine may be called many times from many different contexts during a program's execution. Some of these contexts may be entirely unrelated to the developer's current focus. This requires the developer to repeatedly examine the program state, and ask the debugger to continue execution until a relevant execution context occurs.

As a result, debugging complex scenarios may be further facilitated by the use of a conditional breakpoint, with which a Boolean predicate is associated. This predicate is evaluated each time the corresponding location is reached during program execution. If the predicate evaluates to true, the debugger stops at the breakpoint; if not, program execution continues.

However, conditional breakpoints in the current state of the art are limited in that they examine only the program's current state, and moreover, limited to examining the data visible in the context of the source location with which the breakpoint is associated. As a result, they are applicable only if detecting whether a given execution of a given statement is relevant can be determined by examining solely the present state of the contextually visible data. In some cases, this is either difficult or impossible.

One general case is when a program executes in several stages, and the programmer wants to have the debugger break at a routine in some stages of execution but not in others. For example, consider a program that first initializes a framework, and then makes calls to some routine. Suppose further that the framework itself makes calls to that same routine during initialization. A breakpoint set within the routine would trigger each time that routine is called, including during the initialization phase, even though that is not a context of interest.

Another general case is when the programmer wants to have the debugger break at a routine only following one or more events that occur somewhere else in the code. This can be especially frustrating when debugging graphical user interfaces (GUIs), as the system may keep switching focus between the application and the debugger. For example, say the programmer wants to have the debugger break when the mouse is moved, but only in a certain region R of the GUI after some popup has been opened and then closed. This sort of dependency is virtually impossible to express in current debuggers.

One or more embodiments advantageously provide a mechanism whereby the debugger allows the user to create a set of “debugger variables,” each of which is associated with:

(a) a unique identifier (which may be a user-supplied name),

(b) a source location, and

(c) an expression (which might be a Boolean predicate, for example).

Each time the source location (b) is encountered during a program's execution, the debugger evaluates the expression (c), and sets the value of debugger variable with identifier (a) to the result of the expression's evaluation. Thus, the value of a given debugger variable is defined to be the value of the associated expression (c) as evaluated when the program most recently encountered location (b).

Such debugger variables can be used to modify the debugger's behavior in various ways, including:
(1) being referred to in a conditional breakpoint's condition, e.g., to effectively enable/disable that breakpoint,
(2) used to control the display of information in a debugger view, e.g., to hide/show certain fields of objects of a certain type.

The debugger system may provide a “debugger variables” view for these debugger variables.

### First Example

To address the first example above, the user can create a debugger variable, frameworkInitialized, and set it to FALSE at the start of the program and to TRUE right after the framework is initialized, and make the breakpoints in the routine be conditional on this debugger variable.

### Second Example Case I

To address the second example, the user can create a debugger variable, regionEntered, and set its value when encountering mouseOver( . . . ) and mouseOut( . . . ) events for Region R, and another debugger variable, popupClosed, and set its value to TRUE when the popup is closed. Once these debugger variables have been defined, they can be combined in a conditional breakpoint expression to get the debugger to break as required in the second example.

### Second Example Case II

Alternatively, the user can simplify the conditional breakpoint expression by using a debugger variable whose condition depends on the value of another debugger variable. In the case of the second example, the user can create a debugger variable regionEnteredAndPopupClosed and set its value to the value of regionEntered when the popup is closed. Thus the value of regionEnteredAndPopupClosed is TRUE only when regionEntered is TRUE, and the condition in the conditional breakpoint need only depend on the value of regionEnteredAndPopupClosed.

In one or more embodiments, the debugger variable mechanism can be implemented via a set of objects within the debugger, as described above. For each debugger variable, the debugger sets a breakpoint, which may be hidden from the user's view, at the associated source location. Each time this breakpoint is reached, the debugger evaluates the associated predicate, and sets the value of the debugger variable accordingly. When evaluating a condition that refers to the debugger variable, the debugger substitutes the value obtained by the most recent evaluation of the associated predicate.

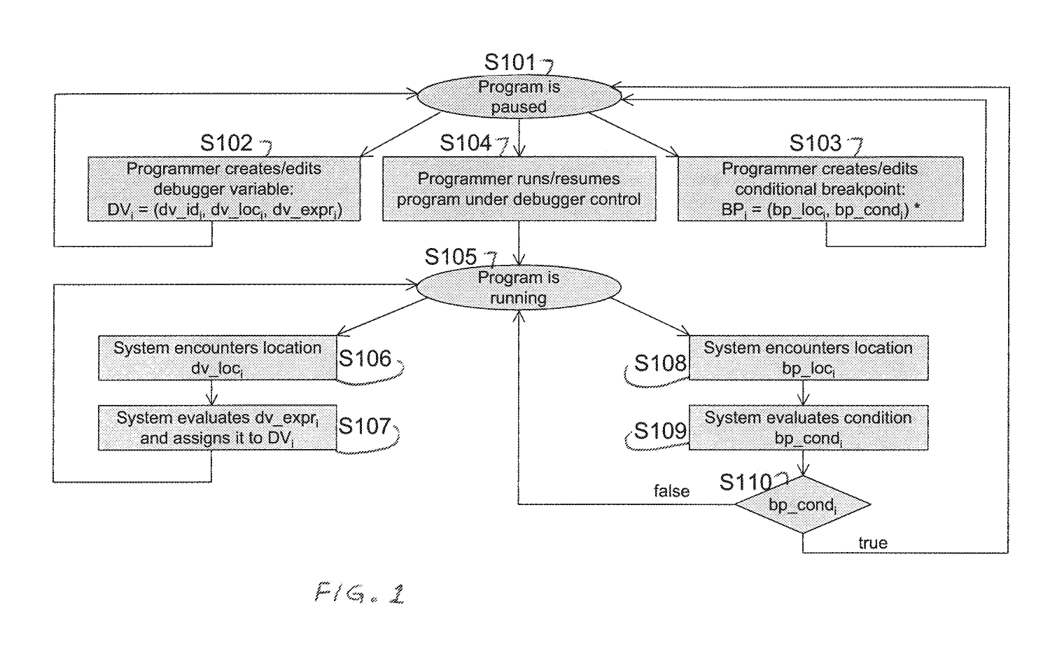

FIG. 1 shows an exemplary process flow using debugger variables for conditional breakpoints. When the program is paused or has not yet started, at step S101, the programmer can create a debugger variable DVᵢ with ID dv_idᵢ, source location dv_locᵢ, and expression dv_exprᵢ, or edit an existing one, as shown at S102. The programmer can also create a conditional breakpoint BPᵢ with source location bp_locᵢ and condition bp_condᵢ, or edit an existing one, as shown at S103. When the programmer starts the program under debugger control, or resumes it from a pause state, as shown at S104, the program moves to the running state, as shown at S105.

Whenever the running program encounters the location dv_locᵢ of a debugger variable DVᵢ, as seen at S106, the debugger evaluates the debugger variable's expression dv_exprᵢ and assigns it as the value of DVi, as seen at S107. Whenever the running program encounters the location bp_locᵢ of a conditional breakpoint BPᵢ, as seen at S108, the debugger evaluates the conditional breakpoint's condition bp_condᵢ, at S109, and, based on its value, in decision block S110, if true, pauses the program (returning to S101), or, if false, keeps the program running (returning to S105). The condition bp_condᵢ may refer to the values of one or more debugger variables, which is how debugger variables affect the behavior of conditional breakpoints.

To relate debugger variables (DVs) to breakpoints (BPs), the condition expressions in the conditional breakpoints condᵢ may refer to the values of one or more debugger variables value(idⱼ).

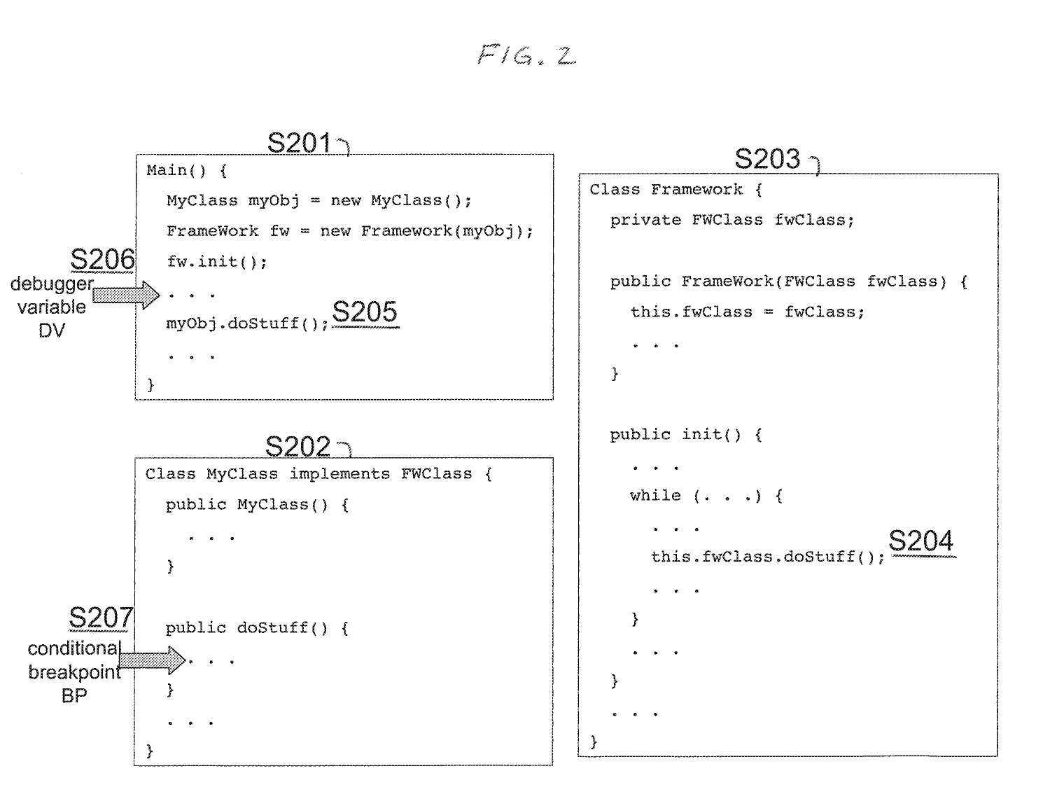

FIG. 2 shows an example of using a debugger variable and associated conditional breakpoint. The example utilizes JAVA syntax, but this is not limiting. A main program S201 creates an object of type MyClass and a framework that refers to this object. The class MyClass, S202, has a public method doStuff( ) that the programmer wants to debug. The framework class S203 has an init( )method that repeatedly calls the doStuff( )method on its referred object S204. The main program also calls the doStuff( )method on this object after the framework has initialized, as at S205. The programmer wants to investigate the behavior of doStuff( ) but only after framework initialization is done. In order to do this, the programmer creates a debugger variable DV, located in the main program, right after the call to init( ) on the framework, which simply evaluates to true, as at S206. The programmer also sets a conditional breakpoint BP at the start of the body of doStuff( ) whose condition is simply the value of DV, as at S207. Now, when the program runs and encounters the body of doStuff( ) it will pause only after the framework has initialized.

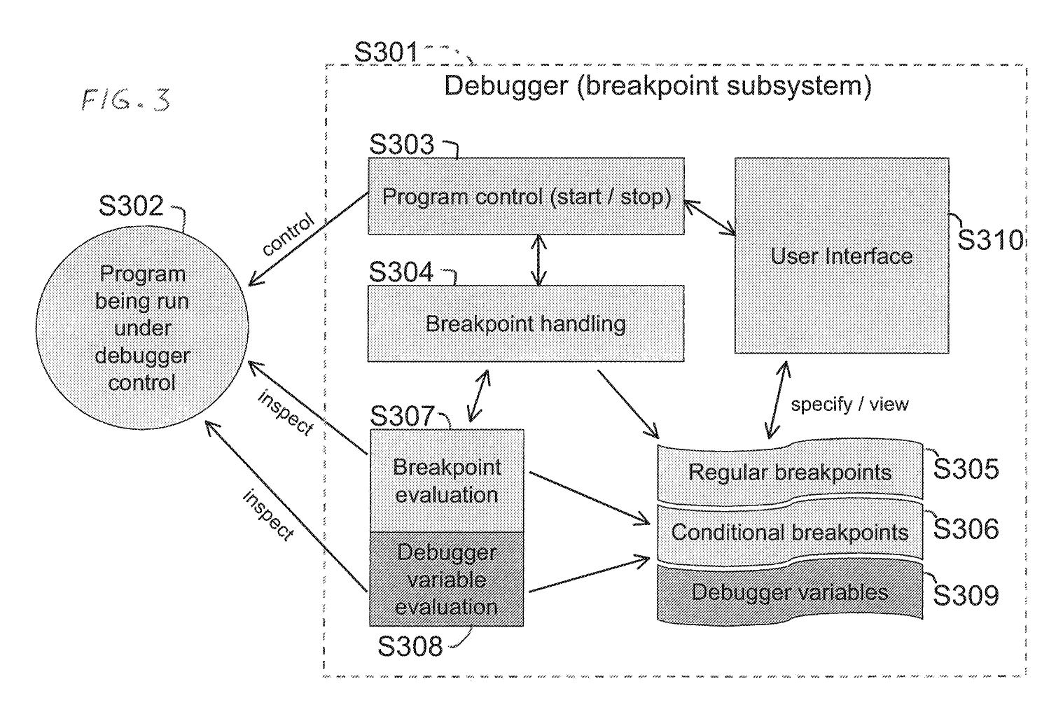

FIG. 3 shows an exemplary software architecture within which one or more embodiments of the invention can be implemented. The figure depicts the part S301 of the debugger dealing with breakpoints, as it interacts with a program S302 being run under debugger support. A program-control component S303 starts, pauses, resumes and stops the program being debugged S302. The control component S303 interacts with a component S304 that handles breakpoints. The breakpoint-handling component S304 deals with stored breakpoints, including regular breakpoints S305 and conditional breakpoints S306. When a conditional breakpoint is encountered during a program run, it is evaluated by breakpoint-evaluation component S307. At such an encounter, the breakpoint-evaluation component typically needs to inspect the state of the running program S302 in order to compute the value of the breakpoint condition, and to relay back to the breakpoint-handling component S304 an indication as to whether the program should be paused. Under the present invention, the breakpoint evaluation component S307 is augmented by a debugger-variable evaluation component S308, which accesses both conditional breakpoints S306 and debugger variables S309. The debugger-variable evaluation component S308 inspects the state of the running program S302 when a source location of a debugger variable is encountered and also when a conditional breakpoint that refers to a debugger variable is encountered. In addition to engine components that deal with the processing related to debugger variables, a user interface S310 is provided for specifying and viewing breakpoints and debugger variables (as well as interacting with the program controls S303). It is worth noting that components S301, S302, S303, S304, S305, S306, S307, and S310 can be implemented using conventional debugger systems, whereas components S308 and S309 are new components employed in one or more embodiments of the invention.

In FIG. 3, the program S302 being run under debugger control corresponds to a program, written in any language, running under the control of a debugger system. The skilled artisan will appreciate that a debugger S301 is a system that has the ability to run programs and monitor them as they are running and to then provide interaction with the person who is trying to understand what the program is doing. The different components in FIG. 3 generally correspond to software modules stored in a non-transitory manner in a computer readable storage medium (or multiple such media) and implemented on a hardware processor (or processors); further details are provided herein. User interface S310 also includes suitable hardware such as one or more of a display, speaker, keyboard, touchscreen, pointing device, and so on. Program S302 corresponds to one or more software modules, stored in a non-volatile memory, and loaded into main memory when it is to be executed by the processor(s); in this instance, it is under the control of the debugger program. The debugger program S301 also includes code stored in a non-volatile memory and loaded into main memory when it is to be executed by the processor(s).

Elements S305, S306, and S309 comprise variable values stored in a register or possibly persisted in a non-volatile memory. Block S308 operates in a manner somewhat analogous to block S307. When the program reaches a certain point, the debugger variable is evaluated and stored for later use. In one or more embodiments, debugger S301 comprises a conventional debugger modified as follows: a debugger variable evaluation module (typically a segment of code) is added, which, when it is determined that a debugger variable location has been reached, will evaluate the current value of the debugger variable and store the result in debugger variable location S309; furthermore, breakpoint evaluation module S307 and/or user interface S310 as the case may be are modified so that they can be made aware of the value(s) of the debugger variable(s) and act accordingly.

Thus, one or more embodiments provide an enhanced debugging method including a debugger performing steps of setting at least one condition variable; evaluating a condition by comparing the condition to the appropriate set condition variable during program execution; and triggering actions based on the evaluating. Some embodiments further include setting one or more breakpoints in the program. In some cases, the debugger performs steps at a breakpoint of: pausing the program; evaluating an associated predicate; and setting a value of the condition variable.

In one or more instances, evaluating a condition includes substituting the value obtained by a most recent evaluation of the associated predicate. In some embodiments, triggering an action includes at least one of allowing the program to continue execution, controlling information display, and the like. In some embodiments, each condition variable is associated with a unique name, a given source location, and a Boolean predicate.

One or more embodiments deal with capturing past program state. One or more embodiments do not involve an event-processing engine, but rather augment the debugger with conditional variables, which are both set and interpreted by the debugger. One or more instances provide conditional variables that can capture arbitrary aspects of the state, as well as affecting other behaviors of the debugger (besides deciding whether or not to take breakpoints). One or more instances relate to affecting debugger behavior.

Given the discussion thus far, it will be appreciated that, in general terms, an exemplary method, according to an aspect of the invention, includes the step S102 of setting, for a debugger, a debugger variable DVᵢ. The debugger variable is associated with at least one location dv_locᵢ within a program to be debugged, and at least one expression dv_exprᵢ that is valid within the scope of the location. This step can be carried out, for example, with user interface S310. A further step S103 includes setting a breakpoint BPᵢ. The breakpoint is associated with a location bp_locᵢ within the program. This step can also be carried out, for example, with user interface S310.

As seen at step S106, upon encountering the at least one location dv_locᵢ of the debugger variable during a current run of the program (step S105), a further step S107 includes computing the value of the at least one expression dv_exprᵢ with which the debugger variable is associated, and assigning the value of the at least one expression with which the debugger variable is associated to the debugger variable DVᵢ. This step can be carried out, for example, with debugger variable evaluation module S308.

In this regard, with respect to the language “debugger variable is associated with at least one location dv_loci within a program to be debugged, and at least one expression dv_expri that is valid within the scope of the location,” this is to state that a generalization is possible in some instances, namely, to associate with each debugger variable one or more {source-location, expression} pairs. When encountering any of the locations associated with a given debugger variable, the value of the debugger variable is updated to the value of the expression corresponding to that source location. Furthermore in this regard, using a debugger variable with multiple {source-location, expression} pairs can be emulated in some instances by using multiple debugger variables, each with a single {source-location, expression} pair), but the former approach may let the developer express things more simply in certain cases.

As seen at step S108, upon encountering the location bp_locᵢ of the breakpoint BPᵢ during the current run of the program, a further step includes operating the debugger in at least one of a first manner and a second manner, depending on the value of the debugger variable. The first manner is different than the second manner. This step can be carried out, for example, with breakpoint evaluation module S307, if the different behavior is pausing/not pausing, or with user interface S310, if the different behavior relates to display.

In some cases, in the step of setting the breakpoint, the breakpoint is a conditional breakpoint further associated with a condition expression bp_condᵢ that refers to the value of the debugger variable, and a further step S109 includes computing a value of the condition expression that refers to the value of the debugger variable.

In some instances, the first manner comprises pausing (S101) the program at the location with which the conditional breakpoint is associated; and the second manner comprises continuing the program without pausing (S105)—see decision block S110.

In some embodiments, the condition expression is Boolean such that the first manner comprises pausing the program at the location with which the conditional breakpoint is associated, if the value of the condition expression has a first one of two logical values; and the second manner comprises continuing the program without pausing if the value of the condition expression has a second one of the two logical values. Thus, with regard to such cases, referring to decision block S110, a further step includes pausing the program at the location with which the conditional breakpoint is associated, if the value of the condition expression has a first one of two logical values (e.g., TRUE), as per the “true” branch of block S110 looping back to state S101; and continuing the program without pausing if the value of the condition expression has a second one of the two logical values (e.g., FALSE), as per the “false” branch of block S110 looping back to state S105. Of course, the condition expression could be inverted and the program paused if FALSE and continued if TRUE.

In some cases, the condition expression bp_condᵢ refers to the value of the debugger variable and also to the value of at least one additional debugger variable. See, e.g., Second example case I above.

In some instances, the expression dv_exprᵢ with which the debugger variable is associated refers to the value of at least one additional debugger variable. See, e.g., Second example case II above.

In some cases, an additional step includes providing a system. The system includes at least one distinct software module. Each of the distinct software module(s) is embodied, in a non-transitory manner, on a computer-readable storage medium. The distinct software module includes a debugger module S301. In such cases, the step S102 of setting the debugger variable is carried out by the debugger module executing on at least one hardware processor; the step S103 of setting the breakpoint is carried out by the debugger module executing on the at least one hardware processor; the step S107 of computing the value of the at least one expression with which the debugger variable is associated is carried out by the debugger module executing on the at least one hardware processor; and the step of operating the debugger in the at least one of a first manner and a second manner is carried out by the debugger module executing on the at least one hardware processor.

Note that the current run of the program typically includes the main program module(s) S302 executing on the at least one hardware processor.

In some embodiments, in the providing step, the debugger module includes at least a portion of an integrated development environment (IDE). In such cases, behavior of the debugger module in the integrated development environment, when paused at a breakpoint, can be affected by the value of the debugger variable (or variables). Furthermore, in such cases, the affected behavior can determine which program variables of the program to be debugged are displayed; the affected behavior can determine how program variables of the program to be debugged are displayed; and/or the IDE can provide a view of debugger variables (for example, on interface S310).

In some cases, the debugger module S301 includes a plurality of distinct software sub-modules (which may also be referred to herein as modules; the notation sub-modules is adapted for formal reasons to refer to components of a previously-recited module). Each of the distinct software sub-modules is embodied in a non-transitory manner on the computer-readable storage medium. The distinct software sub-modules include a user interface submodule S310, a debugger variable evaluation submodule S308, and a breakpoint evaluation submodule S307. The step S102 of setting the debugger variable is carried out by the user interface submodule executing on the at least one hardware processor; the step S103 of setting the breakpoint is carried out by the user interface submodule executing on the at least one hardware processor; the step S107 of computing the value of the at least one expression with which the debugger variable is associated is carried out by the debugger variable evaluation submodule executing on the at least one hardware processor; and the step of operating the debugger in the at least one of a first manner and a second manner is carried out by at least one of the breakpoint evaluation submodule and the user interface submodule executing on the at least one hardware processor, as described elsewhere herein. Any of the other modules and/or submodules shown in FIG. 3 can optionally be provided and can carry out functionality as described elsewhere herein.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

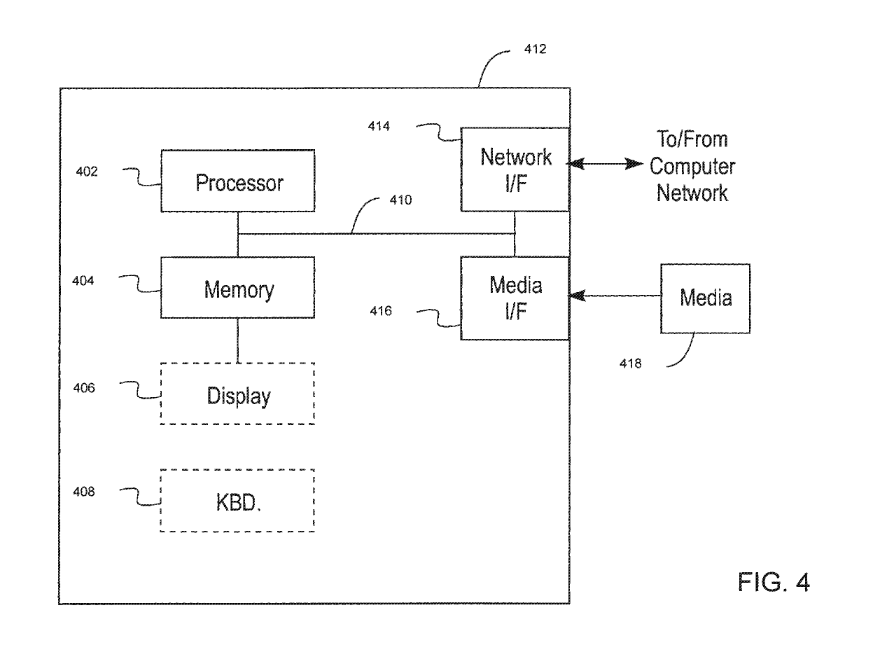

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, modules and/or sub-modules corresponding to the components in FIG. 3. The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
setting, for a debugger, a debugger variable associated with:
at least one location within a program to be debugged; and
at least one expression that is valid within a scope of said at least one location;
setting a breakpoint associated with a location within said program;
upon encountering said at least one location of said debugger variable during a current run of said program, computing a value of said at least one expression with which said debugger variable is associated, and assigning said value of said at least one expression with which said debugger variable is associated to said debugger variable; and
upon encountering said location of said breakpoint during said current run of said program, operating said debugger in at least one of a first manner and a second manner, depending on said value of said debugger variable, said first manner being different than said second manner.

2. The method of claim 1, wherein, in said step of setting said breakpoint, said breakpoint comprises a conditional breakpoint further associated with a condition expression that refers to said value of said debugger variable, further comprising computing a value of said condition expression that refers to said value of said debugger variable.

3. The method of claim 2, wherein:
said first manner comprises pausing said program at said location with which said conditional breakpoint is associated; and
said second manner comprises continuing said program without pausing.

4. The method of claim 3, wherein:
said first manner comprises pausing said program at said location with which said conditional breakpoint is associated, if said value of said condition expression has a first one of two logical values; and
said second manner comprises continuing said program without pausing if said value of said condition expression has a second one of said two logical values.

5. The method of claim 3, wherein said condition expression refers to said value of said debugger variable and also to a value of at least one additional debugger variable.

6. The method of claim 1, wherein said expression with which said debugger variable is associated refers to a value of at least one additional debugger variable.

7. The method of claim 1, further comprising providing a system, wherein the system comprises a distinct software module embodied, in a non-transitory manner, on a computer-readable storage medium, and wherein the distinct software module comprises a debugger module;
wherein:
said step of setting said debugger variable is carried out by said debugger module executing on at least one hardware processor;
said step of setting said breakpoint is carried out by said debugger module executing on said at least one hardware processor;
said step of computing said value of said at least one expression with which said debugger variable is associated is carried out by said debugger module executing on said at least one hardware processor; and
said step of operating said debugger in said at least one of a first manner and a second manner is carried out by said debugger module executing on said at least one hardware processor.

8. The method of claim 7, wherein, in said providing step, said debugger module comprises at least a portion of an integrated development environment.

9. The method of claim 8 wherein behavior of said debugger module in said integrated development environment, when paused at a breakpoint, is affected by said value of said debugger variable.

10. The method of claim 9 wherein said affected behavior determines which program variables of said program to be debugged are displayed.

11. The method of claim 9 wherein said affected behavior determines how program variables of said program to be debugged are displayed.

12. The method of claim 9, further comprising providing a view of debugger variables with said integrated development environment.

13. The method of claim 7, wherein said debugger module comprises a plurality of distinct software sub-modules, each of the distinct software sub-modules being embodied in a non-transitory manner on said computer-readable storage medium, and wherein the distinct software sub-modules comprise a user interface submodule, a debugger variable evaluation submodule, and a breakpoint evaluation submodule;
wherein:
said step of setting said debugger variable is carried out by said user interface submodule executing on said at least one hardware processor;
said step of setting said breakpoint is carried out by said user interface submodule executing on said at least one hardware processor;
said step of computing said value of said at least one expression with which said debugger variable is associated is carried out by said debugger variable evaluation submodule executing on said at least one hardware processor; and
said step of operating said debugger in said at least one of a first manner and a second manner is carried out by at least one of said breakpoint evaluation submodule and said user interface submodule executing on said at least one hardware processor.

14. A debugger computer program product for debugging an external program, said computer program product comprising a computer readable storage medium having computer readable program code embodied therewith, said computer readable program code comprising:
computer readable program code configured to set a debugger variable associated with:
at least one location within said external program; and
at least one expression that is valid within a scope of said at least one location;
computer readable program code configured to set a breakpoint associated with a location within said program;
computer readable program code configured to, upon encountering said at least one location of said debugger variable during a current run of said program, compute a value of said at least one expression with which said debugger variable is associated, and assign said value of said expression with which said debugger variable is associated to said debugger variable; and
computer readable program code configured to, upon encountering said location of said breakpoint during said current run of said program, operate said debugger in at least one of a first manner and a second manner, depending on said value of said debugger variable, said first manner being different than said second manner.

15. The debugger computer program product of claim 14, wherein, in said computer readable program code configured to set said breakpoint, said breakpoint comprises a conditional breakpoint further associated with a condition expression that refers to said value of said debugger variable, further comprising computer readable program code configured to compute a value of said condition expression that refers to said value of said debugger variable.

16. The debugger computer program product of claim 15, wherein:
said first manner comprises pausing said program at said location with which said conditional breakpoint is associated; and
said second manner comprises continuing said program without pausing.

17. The debugger computer program product of claim 15, wherein:
said first manner comprises pausing said program at said location with which said conditional breakpoint is associated, if said value of said condition expression has a first one of two logical values; and
said second manner comprises continuing said program without pausing if said value of said condition expression has a second one of said two logical values.

18. The debugger computer program product of claim 16, wherein said condition expression refers to said value of said debugger variable and also to a value of at least one additional debugger variable.

19. The debugger computer program product of claim 14, wherein said expression with which said debugger variable is associated refers to a value of at least one additional debugger variable.

20. The debugger computer program product of claim 14 wherein behavior of said debugger, when paused at a breakpoint, is affected by said value of said debugger variable.

21. The debugger computer program product of claim 20 wherein said affected behavior determines which program variables of said program to be debugged are displayed.

22. The debugger computer program product of claim 20 wherein said affected behavior determines how program variables of said program to be debugged are displayed.

23. An apparatus comprising:
a memory; and
at least one processor, coupled to said memory, and operative to:
set, for a debugger, a debugger variable associated with:
at least one location within a program to be debugged; and
at least one expression that is valid within a scope of said at least one location;
set a breakpoint associated with a location within said program;
upon encountering said at least one location of said debugger variable during a current run of said program, compute a value of said at least one expression with which said debugger variable is associated, and assign said value of said at least one expression with which said debugger variable is associated to said debugger variable; and
upon encountering said location of said breakpoint during said current run of said program, operate said debugger in at least one of a first manner and a second manner, depending on said value of said debugger variable, said first manner being different than said second manner.

24. The apparatus of claim 23, further comprising a plurality of distinct software modules, each of the distinct software modules being embodied on a computer-readable storage medium, and wherein the distinct software modules comprise a user interface module, a debugger variable evaluation module, and a breakpoint evaluation module;
wherein:
said at least one processor is operative to set said debugger variable by executing said user interface module;
said at least one processor is operative to set said breakpoint by executing said user interface module;
said at least one processor is operative to compute said value of said at least one expression with which said debugger variable is associated by executing said debugger variable evaluation module; and
said at least one processor is operative to operate said debugger in said at least one of a first manner and a second manner by executing at least one of said breakpoint evaluation module and said user interface module.

25. An apparatus comprising:
means for setting, for a debugger, a debugger variable associated with:
at least one location within a program to be debugged; and
at least one expression that is valid within a scope of said at least one location;
means for setting a breakpoint associated with a location within said program;
means for, upon encountering said at least one location of said debugger variable during a current run of said program, computing a value of said at least one expression with which said debugger variable is associated, and assigning said value of said at least one expression with which said debugger variable is associated to said debugger variable; and
means for, upon encountering said location of said breakpoint during said current run of said program, operating said debugger in at least one of a first manner and a second manner, depending on said value of said debugger variable, said first manner being different than said second manner.
